(19) United States
(12) Patent Application Publication
(10) Pub. No.: US 2016/0189556 A1
(43) Pub. Date: Jun. 30, 2016

(54) EVALUATING PRESENTATION DATA

(71) Applicant: INTERNATIONAL BUSINESS MACHINES CORPORATION, Armonk, NY (US)

(72) Inventors: Adam T. Clark, Mantorville, MN (US); John S. Mysak, Rochester, MN (US); Aspen L. Payton, Byron, MN (US); John E. Petri, St. Charles, MN (US); Michael D. Pfeifer, Rochester, MN (US)

(21) Appl. No.: 14/584,128

(22) Filed: Dec. 29, 2014

(51) Int. Cl. G09B 7/02; G06F 17/27; G06F 17/28

(52) U.S. Cl. CPC G09B 7/02; G06F 17/28; G06F 17/2705; G06F 17/271; G06F 17/2785

(57) ABSTRACT

The present disclosure describes evaluating presentation data. Presentation data is collected from a presentation using a set of monitoring devices. Context information is extracted from the presentation data. Based on the context information, a subject matter topic for the presentation and a presentation technique for the presentation are determined. By comparing the presentation technique and a corpus of presentation techniques for the subject matter topic, an evaluation of the presentation technique pertaining to the subject matter topic is generated. In response to generating an evaluation of the presentation technique for a subject matter topic, a curriculum for a subject matter topic is calculated.

### BACKGROUND

This disclosure relates generally to a computer method for evaluating presentation data and, more particularly, evaluating presentation techniques pertaining to a subject matter topic. Effectively conveying information to engage an audience such that information is retained can be challenging, especially within an educational context. In addition, determining which techniques are effective techniques for conveying specific topics can be difficult. Accordingly, there is a need to effectively engage audiences and convey information in a more efficient manner.

### SUMMARY

Aspects of the disclosure may include a computer implemented method and system for evaluating presentation data. The method can include collecting presentation data for a presentation using a set of monitoring devices. Based on the collected presentation data for the presentation, a subject matter topic for the presentation and a presentation technique for the presentation may be determined using natural language processing. By comparing the presentation technique and a corpus of presentation techniques for the subject matter topic, an evaluation of the presentation technique pertaining to the subject matter topic may be determined. In embodiments, generating an evaluation of a presentation technique may include evaluating an educational presentation, where the educational presentation comprises one or more concepts.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a diagrammatic illustration of an exemplary computing environment, according to embodiments of the present disclosure.

FIG. 2 is a system diagram depicting a high level logical architecture for a question answering system, according to embodiments of the present disclosure.

FIG. 3 is a block diagram illustrating a question answering system, according to embodiments of the present disclosure.

FIG. 4 depicts a high level diagram illustrating an example system 400 for evaluating presentation data, according to embodiments of the present disclosure.

FIG. 5 is a flowchart illustrating a method 500 for evaluating a presentation, according to embodiments of the present disclosure.

FIG. 6 is a flowchart illustrating a method 600 for determining a subject matter topic for a presentation and a presentation technique for the presentation, according to embodiments of the present disclosure.

FIG. 7 is a flowchart illustrating a method 700 for comparing a presentation technique for a subject matter topic with a corpus of presentation techniques for the same subject matter topic, according to embodiments of the present disclosure.

FIG. 8 is a flowchart illustrating a method 800 for generating an evaluation of a presentation technique for a subject matter topic, according to embodiments of the present disclosure.

FIG. 9 is a flowchart illustrating a method 900 for evaluating presentation data, according to embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure include a computer implemented method, system, and computer program product for evaluating presentation data. The computer implemented method and system may allow an individual/entity to evaluate a presentation technique for a subject matter topic. The method and system may be used to generate a curriculum for a subject matter topic based upon feedback data collected through a set of monitoring devices. While the present disclosure is not necessarily limited to such applications, various aspects of the disclosure may be appreciated through a discussion of various examples using this context.

Various embodiments of the present disclosure are directed toward facilitating the conveyance of information, in a physical or virtual environment, by identifying ways to present specific concepts in an effective and engaging manner using an analysis of presentation data. For example, in an educational setting, a computer system may be configured to identify presentation techniques which have evaluated to be more effective to conveying information by a teacher to a group of students. In certain embodiments, the system can be configured to correlate presentation techniques from different environments. For instance, the presentation techniques that teachers employ in classrooms can be identified for uses that are not limited to the classroom. Additionally, the computer system can be configured to identify and share effective teaching techniques employed by successful teachers, which may be otherwise unknown to the teaching community at large. For example, the system can be configured to determine that certain topics within a curriculum of a subject matter may be taught more effectively using certain presentation techniques.

Aspects of the disclosure include a computer implemented method, system, and computer program product for evaluating presentation data. In certain embodiments, the computer implemented method, system, and computer program product may monitor a presentation to collect presentation data in order to generate an evaluation on the given presentation for a specific concept. The presentation data may be analyzed to extract context information from the presentation data. A set of monitoring devices in a computer system may be configured to collect presentation data for a presentation. A monitoring device may include a computer associated with the presentation. The presentation data may be analyzed to extract context information from the presentation data. In various embodiments, context information may include audio data, image data, video data, and textual data. Based upon the context information for the presentation, a subject matter topic for the presentation and a presentation technique for the presentation may be determined. For example, the presentation technique may correspond with a lesson plan that is based on a curriculum. The curriculum may include areas of education, such as science, social studies, language, or mathematical content as examples. In response to determining a subject matter topic and a presentation technique for the presentation, a corpus of presentation techniques on the subject matter topic may be retrieved. The corpus of presentation techniques may have been previously collected and may continuously be supplemented as more presentations are given. By comparing the presentation technique on the subject matter topic (e.g., the given presentation) with a corpus of presentation techniques for the subject matter topic (e.g., previously evaluated presentations), a relationship may be determined to suggest other presentation techniques which may be more effective in conveying information.

Aspects of the disclosure are directed toward determining the subject matter topic for the presentation. The methodology may parse, by a natural language processing technique configured to analyze syntactic and semantic content, the context information to classify a concept. By comparing the concept with an ontology framework, a set of related concepts may be identified. In response to identifying a set of related concepts, the methodology may map both the concept and the set of related concepts with the subject matter topic. Mapping the concept and the set of related concepts with the subject matter topic may facilitate retrieval from a corpus of presentation techniques for the subject matter topic in future evaluations. Based upon the subject matter topic, the methodology may retrieve a subset of techniques from a corpus of known presentation techniques for the concept. In embodiments, the concept may be a subset of the subject matter topic.

Aspects of the disclosure include comparing the presentation technique and the corpus of presentation techniques for the subject matter topic. The methodology may identify the concept for the presentation technique using natural language processing. A subset of presentation techniques for the concept may be retrieved from a corpus of known presentation techniques for the subject matter topic. Based upon feedback data for the presentation technique and feedback data for the corpus of presentation techniques, a relationship between the presentation technique for the concept and the corpus of presentation techniques for the concept may be determined. The relationship may indicate an efficiency of a presentation technique as it relates to the concept. In embodiments, the feedback data for the presentation technique and the feedback data for the corpus of presentation techniques may include data collected from user communications through the set of monitoring devices.

Aspects of the disclosure include generating an evaluation of the presentation technique for the subject matter topic. The evaluation of the presentation technique may be presented through a graphical user interface on a network portal. In certain embodiments, generating an evaluation of the presentation technique may include evaluating an educational presentation. In further embodiments, the educational presentation may include one or more concepts. The methodology may collect feedback data associated with a communication made by a user on a presentation technique for a concept. In embodiments, collecting feedback data associated with a communication may include comparing, using natural language processing techniques, the content of the communication made by a user with the content of the presentation technique on the concept. From a data corpus, the method may retrieve a set of previously evaluated presentation techniques related to the concept. An organization system of the set of previously evaluated presentation techniques corresponding to the presentation technique on the concept may be created. In embodiments, the organization system may rank the presentation techniques on the concept based upon how effective the concept was conveyed to an audience. The organization system may be based on feedback data. In response to calculating an organization system, a curriculum for a subject matter topic may be generated. In embodiments, the curriculum may include suggested presentation techniques for related concepts based upon the feedback data received for the initial given presentation on a concept.

Aspects of the present disclosure include a computer implemented method for evaluating a presentation. The method may collect the content of one or more communications made by one or more users on a presentation for a concept through a set of monitoring devices. Based upon a corpus of collected content of one or more communications made by one or more users on a presentation for a concept, an evaluation may be generated for the presentation for the concept. In response to generating an evaluation for the presentation for the concept, the method may group the evaluation for the presentation for the concept with a set of previously evaluated presentations for the concept through a shared pool of configurable network computing resources or communication network. The method may determine a curriculum based upon grouping the evaluation for the presentation for the concept with a set of previously evaluated presentations for the concept.

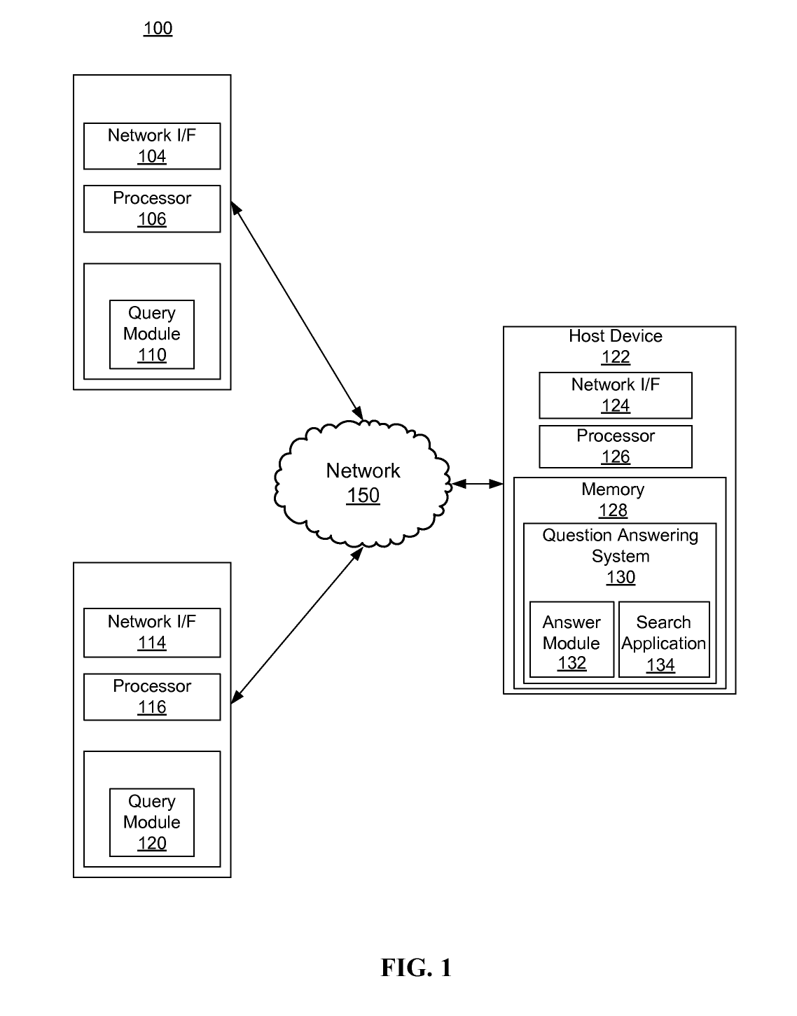

Consistent with embodiments of the disclosure, FIGS. 1-3 discuss the structure and function of a question answering system. The structure and function of the question answering system may be used to perform functions related to evaluating presentation techniques. The comparison of the question answering system may be applied to embodiments of the present invention.

FIG. 1 is a diagrammatic illustration of an exemplary computing environment, consistent with embodiments of the present disclosure. In certain embodiments, the environment 100 can include one or more remote devices 102, 112 and one or more host devices 122. Remote devices 102, 112 and host device 122 may be distant from each other and communicate over a network 150 in which the host device 122 comprises a central hub from which remote devices 102, 112 can establish a communication connection. Alternatively, the host device and remote devices may be configured in any other suitable relationship (e.g., in a peer-to-peer or other relationship).

In certain embodiments the network 100 can be implemented by any number of any suitable communications media (e.g., wide area network (WAN), local area network (LAN), Internet, Intranet, etc.). Alternatively, remote devices 102, 112 and host devices 122 may be local to each other, and communicate via any appropriate local communication medium (e.g., local area network (LAN), hardwire, wireless link, Intranet, etc.). In certain embodiments, the network 100 can be implemented within a cloud computing environment, or using one or more cloud computing services. Consistent with various embodiments, a cloud computing environment can include a network-based, distributed data processing system that provides one or more cloud computing services. In certain embodiments, a cloud computing environment can include many computers, hundreds or thousands of them, disposed within one or more data centers and configured to share resources over the network.

In certain embodiments, host device 122 can include a question answering system 130 (also referred to herein as a QA system) having a search application 134 and an answer module 132. In certain embodiments, the search application may be implemented by a conventional or other search engine, and may be distributed across multiple computer systems. The search application 134 can be configured to search one or more databases or other computer systems for content that is related to a question input by a user at a remote device 102, 112.

In certain embodiments, remote devices 102, 112 enable users to submit questions (e.g., search requests or other queries) to host devices 122 to retrieve search results. For example, the remote devices 102, 112 may include a query module 110 (e.g., in the form of a web browser or any other suitable software module) and present a graphical user (e.g., GUI, etc.) or other interface (e.g., command line prompts, menu screens, etc.) to solicit queries from users for submission to one or more host devices 122 and further to display answers/results obtained from the host devices 122 in relation to such queries.

Consistent with various embodiments, host device 122 and remote devices 102, 112 may be computer systems preferably equipped with a display or monitor. In certain embodiments, the computer systems may include at least one processor 106, 116, 126 memories 108, 118, 128 and/or internal or external network interface or communications devices 104, 114, 124 (e.g., modem, network cards, etc.), optional input devices (e.g., a keyboard, mouse, or other input device), and any commercially available and custom software (e.g., browser software, communications software, server software, natural language processing software, search engine and/or web crawling software, filter modules for filtering content based upon predefined criteria, etc.). In certain embodiments, the computer systems may include server, desktop, laptop, and hand-held devices. In addition, the answer module 132 may include one or more modules or units to perform the various functions of present disclosure embodiments described below (e.g., using a set of monitoring devices to collect presentation data for a presentation, determining a subject matter topic for a presentation and a presentation technique for a presentation, generating an evaluation of the presentation technique pertaining to the subject matter topic), and may be implemented by any combination of any quantity of software and/or hardware modules or units.

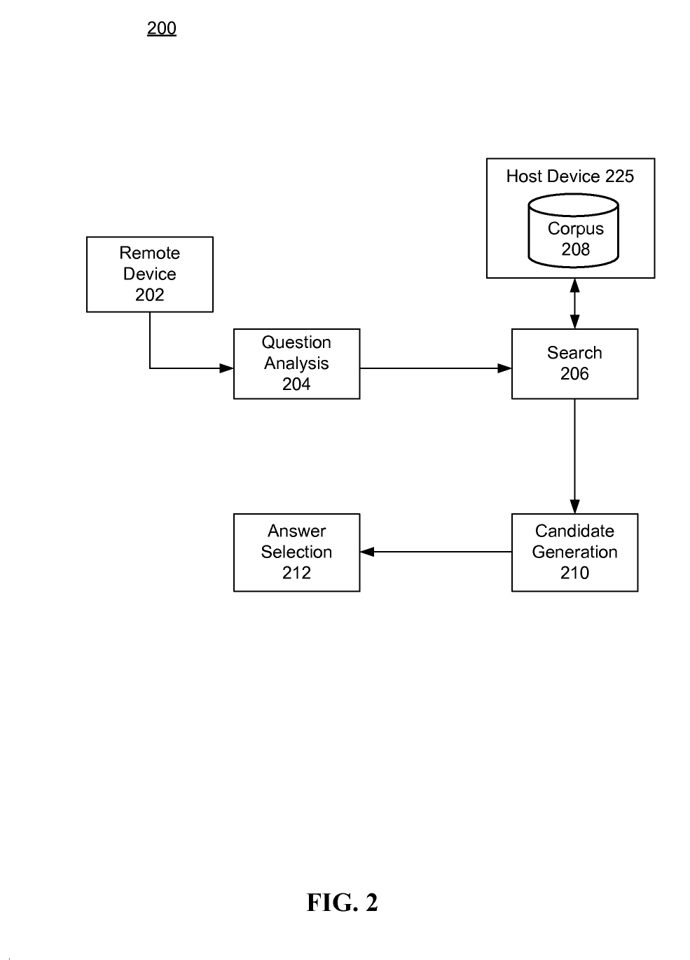

FIG. 2 is a system diagram depicting a high level logical architecture for a question answering system (also referred to herein as a QA system), consistent with embodiments of the present disclosure. Aspects of FIG. 2 are directed toward components for use with a QA system. In certain embodiments, the question analysis component 204 can receive a natural language question from a remote device 202, and can analyze the question to produce, minimally, the semantic type of the expected answer. The search component 206 can formulate queries from the output of the question analysis component 204 and may consult various resources such as the internet or one or more knowledge resources, e.g., databases, corpora 208, to retrieve documents, passages, web-pages, database tuples, etc., that are relevant to answering the question. For example, as shown in FIG. 2, in certain embodiments, the search component 206 can consult a corpus of information 208 on a host device 225. The candidate answer generation component 210 can then extract from the search results potential (candidate) answers to the question, which can then be scored and ranked by the answer selection component 212.

The various components of the exemplary high level logical architecture for a QA system described above may be used to implement various aspects of the present disclosure. For example, the question analysis component 204 could, in certain embodiments, be used to analyze context information for a presentation. Further, the search component 206 can, in certain embodiments, be used to perform a search of a corpus of information 208 (e.g., a corpus of presentation techniques for a subject matter topic) using presentation data. The candidate generation component 210 can be used to identify a set of presentation techniques for a subject matter topic. Further, the answer selection component 212 can, in certain embodiments, be used to generate at least one evaluation of a presentation technique pertaining to a subject matter topic.

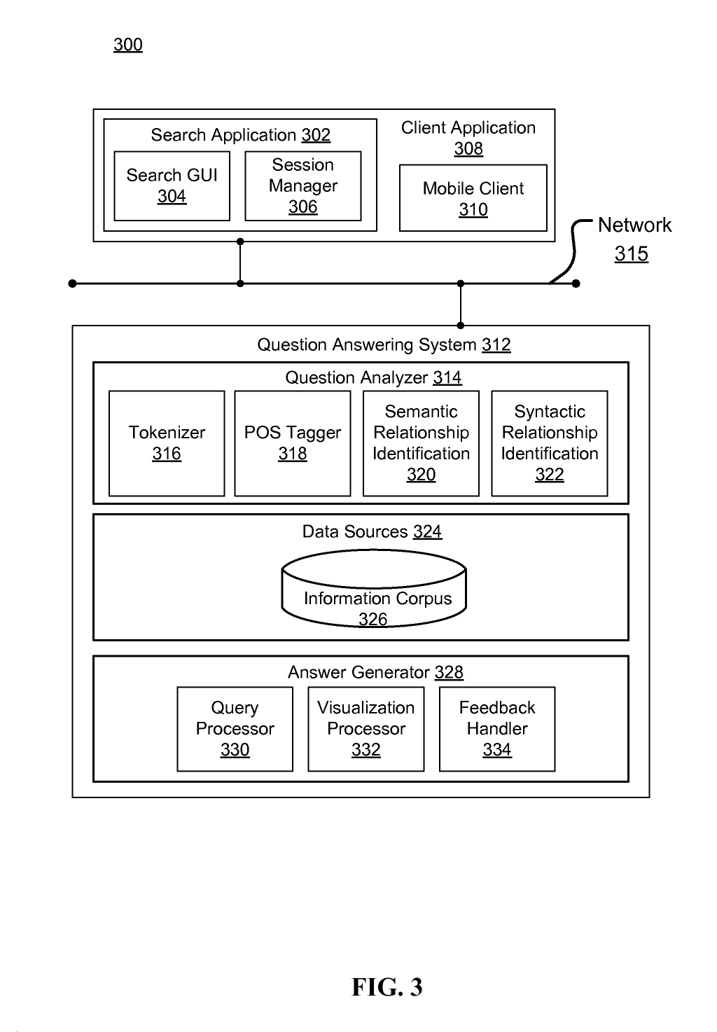

FIG. 3 is a block diagram illustrating a question answering system (also referred to herein as a QA system) to generate answers to one or more input questions, consistent with various embodiments of the present disclosure. Aspects of FIG. 3 are directed toward an example system architecture 300 of a question answering system 312 to generate answers to queries (e.g., input questions). In certain embodiments, one or more users may send requests for information to QA system 312 using a remote device (such as remote devices 102, 112 of FIG. 1). QA system 312 can perform methods and techniques for responding to the requests sent by one or more client applications 308. Client applications 308 may involve one or more entities operable to generate events dispatched to QA system 312 via network 315. In certain embodiments, the events received at QA system 312 may correspond to input questions received from users, where the input questions may be expressed in a free form and in natural language.

A question (similarly referred to herein as a query) may be one or more words that form a search term or request for data, information or knowledge. A question may be expressed in the form of one or more keywords. Questions may include various selection criteria and search terms. A question may be composed of complex linguistic features, not only keywords. However, keyword-based search for answer is also possible. In certain embodiments, using unrestricted syntax for questions posed by users is enabled. The use of restricted syntax results in a variety of alternative expressions for users to better state their needs.

Consistent with various embodiments, client applications 308 can include one or more components such as a search application 302 and a mobile client 310. Client applications 308 can operate on a variety of devices. Such devices include, but are not limited to, mobile and handheld devices, such as laptops, mobile phones, personal or enterprise digital assistants, and the like; personal computers, servers, or other computer systems that access the services and functionality provided by QA system 312. For example, mobile client 310 may be an application installed on a mobile or other handheld device. In certain embodiments, mobile client 310 may dispatch query requests to QA system 312.

Consistent with various embodiments, search application 302 can dispatch requests for information to QA system 312. In certain embodiments, search application 302 can be a client application to QA system 312. In certain embodiments, search application 302 can send requests for answers to QA system 312. Search application 302 may be installed on a personal computer, a server or other computer system. In certain embodiments, search application 302 can include a search graphical user interface (GUI) 304 and session manager 306. Users may enter questions in search GUI 304. In certain embodiments, search GUI 304 may be a search box or other GUI component, the content of which represents a question to be submitted to QA system 312. Users may authenticate to QA system 312 via session manager 306. In certain embodiments, session manager 306 keeps track of user activity across sessions of interaction with the QA system 312. Session manager 306 may keep track of what questions are submitted within the lifecycle of a session of a user. For example, session manager 306 may retain a succession of questions posed by a user during a session. In certain embodiments, answers produced by QA system 312 in response to questions posed throughout the course of a user session may also be retained. Information for sessions managed by session manager 306 may be shared between computer systems and devices.

In certain embodiments, client applications 308 and QA system 312 can be communicatively coupled through network 315, e.g. the Internet, intranet, or other public or private computer network. In certain embodiments, QA system 312 and client applications 308 may communicate by using Hypertext Transfer Protocol (HTTP) or Representational State Transfer (REST) calls. In certain embodiments, QA system 312 may reside on a server node. Client applications 308 may establish server-client communication with QA system 312 or vice versa. In certain embodiments, the network 315 can be implemented within a cloud computing environment, or using one or more cloud computing services. Consistent with various embodiments, a cloud computing environment can include a network-based, distributed data processing system that provides one or more cloud computing services.

Consistent with various embodiments, QA system 312 may respond to the requests for information sent by client applications 308, e.g., posed questions by users. QA system 312 can generate answers to the received questions. In certain embodiments, QA system 312 may include a question analyzer 314, data sources 324, and answer generator 328. Question analyzer 314 can be a computer module that analyzes the received questions. In certain embodiments, question analyzer 314 can perform various methods and techniques for analyzing the questions syntactically and semantically. In certain embodiments, question analyzer 314 can parse received questions, presentation data, or extracted context information. Question analyzer 314 may include various modules to perform analyses of received questions. For example, computer modules that question analyzer 314 may encompass include, but are not limited to a tokenizer 316, part-of-speech (POS) tagger 318, semantic relationship identification 320, and syntactic relationship identification 322.

Consistent with various embodiments, tokenizer 316 may be a computer module that performs lexical analysis. Tokenizer 316 can convert a sequence of characters into a sequence of tokens. Tokens may be string of characters typed by a user and categorized as a meaningful symbol. Further, in certain embodiments, tokenizer 316 can identify word boundaries in an input question and break the question or any text into its component parts such as words, multiword tokens, numbers, and punctuation marks. In certain embodiments, tokenizer 316 can receive a string of characters, identify the lexemes in the string, and categorize them into tokens.

Consistent with various embodiments, POS tagger 318 can be a computer module that marks up a word in a text to correspond to a particular part of speech. POS tagger 318 can read a question or other text in natural language and assign a part of speech to each word or other token. POS tagger 318 can determine the part of speech to which a word corresponds based on the definition of the word and the context of the word. The context of a word (e.g., context information) may be based on its relationship with adjacent and related words in a phrase, sentence, question, or paragraph. In certain embodiments, context of a word may be dependent on one or more previously posed questions. Examples of parts of speech that may be assigned to words include, but are not limited to, nouns, verbs, adjectives, adverbs, and the like. Examples of other part of speech categories that POS tagger 318 may assign include, but are not limited to, comparative or superlative adverbs, wh-adverbs, conjunctions, determiners, negative particles, possessive markers, prepositions, wh-pronouns, and the like. In certain embodiments, POS tagger 316 can tag or otherwise annotates tokens of a question with part of speech categories. In certain embodiments, POS tagger 316 can tag tokens or words of a question to be parsed by QA system 312.

Consistent with various embodiments, semantic relationship identification 320 may be a computer module that can identify semantic relationships of recognized entities in questions posed by users. In certain embodiments, semantic relationship identification 320 may determine functional dependencies between entities, the dimension associated to a member, and other semantic relationships.

Consistent with various embodiments, syntactic relationship identification 322 may be a computer module that can identify syntactic relationships in a question composed of tokens posed by users to QA system 312. Syntactic relationship identification 322 can determine the grammatical structure of sentences, for example, which groups of words are associated as “phrases” and which word is the subject or object of a verb. In certain embodiments, syntactic relationship identification 322 can conform to a formal grammar.

In certain embodiments, question analyzer 314 may be a computer module that can parse a received query and generate a corresponding data structure of the query. For example, in response to receiving a question at QA system 312, question analyzer 314 can output the parsed question as a data structure. In certain embodiments, the parsed question may be represented in the form of a parse tree or other graph structure. To generate the parsed question, question analyzer 130 may trigger computer modules 132-144. Question analyzer 130 can use functionality provided by computer modules 316-322 individually or in combination. Additionally, in certain embodiments, question analyzer 130 may use external computer systems for dedicated tasks that are part of the question parsing process.

Consistent with various embodiments, the output of question analyzer 314 can be used by QA system 312 to perform a search of one or more data sources 324 to retrieve information to answer a question posed by a user. In certain embodiments, data sources 324 may include data warehouses, information corpora, data models, and document repositories. In certain embodiments, the data source 324 can be an information corpus 326. The information corpus 326 can enable data storage and retrieval. In certain embodiments, the information corpus 326 may be a storage mechanism that houses a standardized, consistent, clean and integrated form of data. The data may be sourced from various operational systems. Data stored in the information corpus 326 may be structured in a way to specifically address reporting and analytic requirements. In one embodiment, the information corpus may be a relational database. In some example embodiments, data sources 324 may include one or more document repositories.

In certain embodiments, answer generator 328 may be a computer module that generates answers to posed questions. Examples of answers generated by answer generator 328 may include, but are not limited to, evaluations of presentation techniques in the form of natural language sentences; reports, charts, or other analytic representation; raw data; web pages, and the like.

Consistent with various embodiments, answer generator 328 may include query processor 330, visualization processor 332 and feedback handler 334. When information in a data source 324 matching a parsed question is located, a technical query associated with the pattern can be executed by query processor 330. Based on retrieved data by a technical query executed by query processor 330, visualization processor 332 can render visualization of the retrieved data, where the visualization represents the answer. In certain embodiments, visualization processor 332 may render various analytics to represent the answer including, but not limited to, images, charts, tables, dashboards, maps, and the like. In certain embodiments, visualization processor 332 can present the answer to the user in understandable form.

In certain embodiments, feedback handler 334 can be a computer module that processes presentation data or feedback data from users on evaluations of presentation techniques by answer generator 328. In certain embodiments, users may be engaged in dialog with the QA system 312 to evaluate the presentation technique on a subject matter topic. Answer generator 328 may produce a list of previously evaluated presentation techniques on the same subject matter. The QA system 312 or the user may rank each presentation technique on the subject according to efficiency, efficacy, credibility or the like. In certain embodiments, the feedback of users on generated evaluations for presentation techniques may be used for future presentation technique evaluations.

The various components of the exemplary question answering system described above may be used to implement various aspects of the present disclosure. For example, the client application 308 could be used to collect presentation data from a presentation. The question analyzer 314 could, in certain embodiments, be used to analyze the presentation data to determine the context information of the presentation or characteristic(s) about a set of presentation techniques for a subject matter topic. Further, the query processor 330 or the answer generator 328 could, in certain embodiments, be used to determine a set of presentation techniques for a concept.

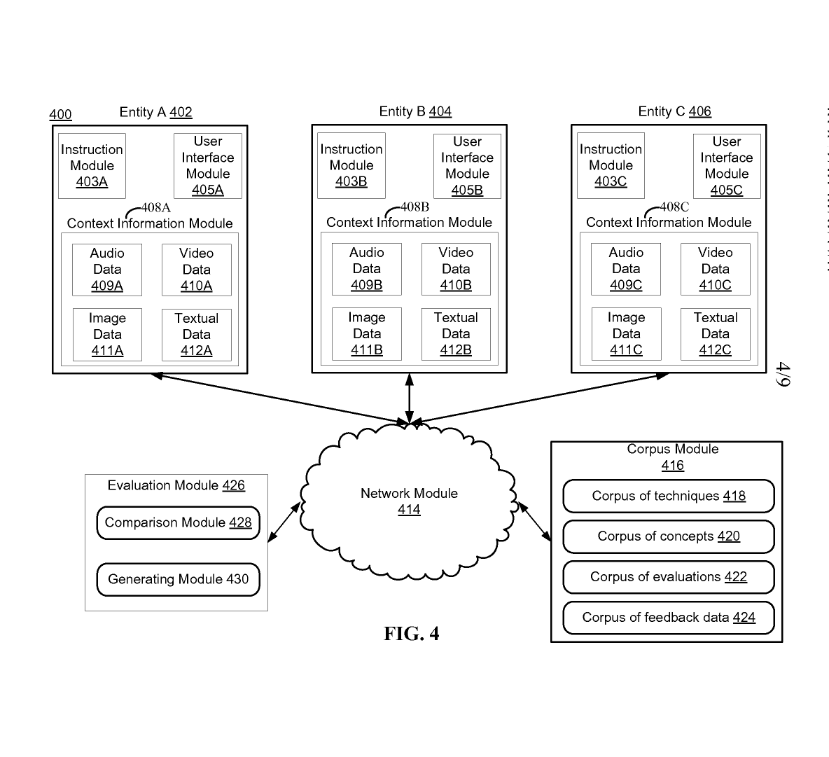

FIG. 4 depicts a high level diagram illustrating an example system 400 for evaluating presentation data. The system 400 may include one or more entities, such as entity A 402, entity B 404, and entity C 406. In embodiments, the entities may be institutions (e.g., organizations such as government/schools). In certain embodiments, the institutions may constitute online education systems. The entities within the system 400 may include an instruction module 403A-C, a user interface module 405A-C, and a context information module 408A-C. The context information modules 408A-C may be configured to receive, process and/or store presentation data, such as audio data 409A-C, video data 410A-C, image data 411A-C and textual data 412A-C. The entities A 402, B 404 and C 406 comprising the system 400 may communicate and interact with a network 414. The network 414 may communicate with an evaluation module 426 and a corpus module 416. The evaluation module 426 may include a comparison module 428 and a generating module 430. Similarly, the corpus module 416 may include a corpus of techniques 418, a corpus of concepts 420, a corpus of evaluations 422, and a corpus of feedback data 424.

The instruction modules 403A, 403B, and 403C may include a presentation on a subject matter topic (e.g., biology). The presentation may be performed in a physical or virtual setting and presentation data may be collected. In certain embodiments, the presentation may be performed on a computer. The subject matter topic may include one or more concepts (e.g., prokaryotic cells/eukaryotic cells). The presentation may include a presentation technique, which can be the manner by which the presentation is conveyed (e.g., slideshow presentation, video lecture, cooperative learning exercises, Socratic Method).

The user interface modules 405A, 405B, and 405C may include a dashboard running on a graphical user interface. The user interface modules 405A, 405B and 405C may be run on a personal computer or similar device. The user interface modules 405 may be in constant communication with a shared pool of configurable network computing resources. Through the user interfaces 405A, 405B, and 405C, a user may view a presentation. In embodiments, the user interface 405 may be used by members of the audience of the presentation (e.g., students) to provide comments or questions related to the presentation. In certain embodiments, the user interface 405 may be used by members of the audience to complete an assignment or interact with the presentation being given. For example, in an educational setting, an instructor may give a presentation that requires student participation. A student may participate with the interactive presentation through the user interface module 405. Also, if an instructor has provided an assignment or test based on the content of the presentation, the student may complete the assignment or the test through the user interface module 405.

The context information modules 408A, 408B, and 408C may be used to collect presentation data from various presentations given at institution A 402, institution B 404 and institution C 406, respectively. In embodiments, the context information module 408 may include a multi-dimensional array. Context information may be extracted from the presentation data at the context information module 408. The context information module 408 may be in constant communication with the instruction module 403, the user interface module 405, the network 414, the evaluation module 416, and the corpus module 422. The context information module may use a set of monitoring devices (e.g., microphones, video, cameras, and other sensors) to collect audio data 409 (e.g., audible content, intonation, pitch), video data 410 (e.g., recorded camera footage), image data 411 (e.g., captured images, photographs), and textual data 412 (e.g., handwritten notes, message board posts). The system 400 may use the audio data 409, video data 410, image data 411, and textual data 412 to determine a subject matter topic as well as a concept of a presentation being given. The system 400 may also use the audio data 409, video data 410, image data 411, and textual data 412 to determine a presentation technique for the presentation given. For example, in an educational setting where a teacher gives a presentation on a concept, the spoken words as well as any images or videos used in the presentation may be collected and analyzed to determine the manner of conveyance used by the teacher (e.g., direct instruction/cooperative learning).

The system 400 may be interconnected by a network 414. The network 414 may be a communication network where the collected presentation data is stored in a shared pool of configurable network computing resources. In embodiments, the network module 414 may include, for example, a local-area-network (LAN), a wide-area-network (WAN), the Internet, an intranet, or similar network architectures. The network module 414 may receive, from entity A 402, entity B 404 and entity C 406, the presentation data collected from the context information module 408. The extracted context information from the presentation data collected at the context information module 408 may be communicated to both the evaluation module 416 and the corpus module 422.

The corpus module 416 may be a storage system containing an array of storage devices (e.g., mainframe server storage). The corpus module 416 may receive data from the context information module 408 from the entities A 402, B 404, and C 406 through the network 414. The corpus module 416 may include a corpus of techniques 418, a corpus of concepts 420, a corpus of evaluations 422, and a corpus of feedback data 424. In embodiments, the corpus module 416 may receive data from the context information module 408 and, using natural language processing, sort the data into the different corpora located within the corpus module 416. The corpus of techniques 418 may include a collection of identified presentation techniques used by entities A 402, B 404, and C 406 given at the instruction module 403. In embodiments, the corpus of presentation techniques 418 may include a corpus of presentation techniques for a concept. The corpus of concepts 420 may include a collection of presentation techniques used for a concept (e.g., interactive class exercises for mitochondria, slideshow presentations of a cell cycle). In embodiments, the corpus of concepts 420 may group presentation techniques used for a concept and classify the presentation techniques for the concept under a subject matter topic. For example, presentation techniques of interactive class exercises for mitochondria and slideshow presentations of a cell cycle may be grouped under the subject matter topic of biology.

The corpus of evaluations 422 may receive, from the evaluation module 426, an evaluation of a presentation technique for a concept. The corpus of evaluations 422 may be a collection of previously evaluated presentation techniques for a concept. Finally, the corpus of feedback data 424 may be a collection of context information provided by the audience (e.g., test answers, homework, evaluation surveys, classroom participation). The corpus of feedback data may receive feedback data from the user interface 405. For example, the content of a student comment made on a presentation given by a teacher may be compared with the content of the presentation itself, and said comparison may be stored within the corpus of feedback data 424. In another example, student answers on examinations or homework for a specific topic completed through the user interface 405 may be compared with the content of the presentation made on a specific topic by the teacher, and said comparison may be stored within the corpus of feedback data 424.

The evaluation module 426 may include a processing algorithm. The evaluation module (e.g., the processing algorithm) may include a comparison module 428 and a generating module 430. The comparison module 428 may receive from an institution A 402, B 404, or C 406, context information on a presentation from the context information module 408. In embodiments, the evaluation module 426 is continuously updated as more information is collected at the comparison module 428. The comparison module 428 may parse/analyze the context information received from the context information module 408 using natural language processing to identify a concept of the presentation, a presentation technique of the presentation, and feedback data for the presentation technique. The comparison module 428 may receive, from the corpus of presentation techniques 418, a subset of presentation techniques for a concept. The corpus of presentation techniques 418 may be updated as users contribute more data. In embodiments, the comparison module 428 may receive the subset of presentation techniques for a concept from the corpus of concepts 420. The comparison module 428 may determine, based upon feedback data for the presentation technique and feedback data for the corpus of presentation techniques, a relationship between the presentation technique for the concept and the corpus of presentation techniques for the concept. In embodiments, the relationship may indicate an efficiency of a presentation technique as it relates to a concept.

The generating module may receive from an institution A 402, B 404, or C 406 context information on a presentation from the context information module 408. The generating module 430 may parse the context information received from the context information module 408 using natural language processing to identify a concept of the presentation, a presentation technique of the presentation, and feedback data for the presentation technique for the concept. In embodiments, the generating module 430 may receive from the corpus of evaluations 422, a set of previously evaluated presentation techniques related to the concept. In various embodiments, the set of previously evaluated presentation techniques may be for the concept. In response to receiving the set of previously evaluated presentation techniques for the concept, the generating module 430 may calculate an organization system of the set of previously evaluated presentation techniques corresponding to the presentation technique given at an instruction module 403. The organization system may indicate the efficiency of a presentation technique given for a concept as it relates to the corpus of previously evaluated presentation techniques for the same concept. In certain embodiments, the generating module 430 may use the calculated organization system to generate a curriculum for the presentation technique on the concept. For example, if an instructor were to give a slideshow presentation on a topic of strong and weak electromagnetic forces, the evaluation module 426 would compare the slideshow presentation technique with feedback data collected from members of the audience as well as compare the slideshow presentation technique on strong and weak electromagnetic forces with the corpus of presentation techniques 418 on strong and weak electromagnetic forces. Based upon these comparisons, the evaluation module 426 may generate an evaluation indicating the efficiency of the presentation technique. Further, the evaluation module 426 may determine that using a video to illustrate the movement of particles is more effective (based upon test scores and homework concerning the topic of strong and weak electromagnetic forces) as a learning technique than using a slideshow presentation.

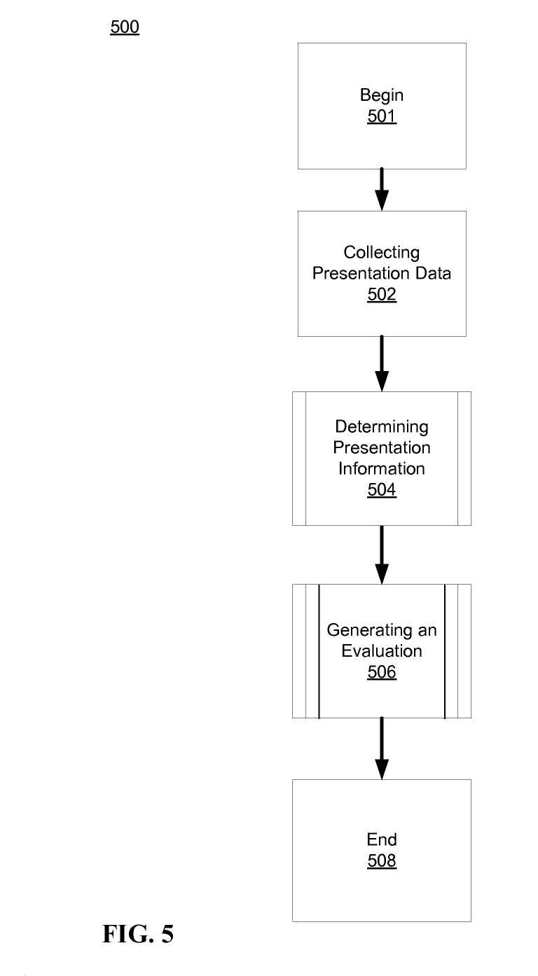

FIG. 5 is a flowchart illustrating a method 500 for evaluating a presentation according to embodiments. The method 500 may begin at block 501. The method 500 may include collecting presentation data at block 502, determining presentation information at block 504, and generating an evaluation at block 506. The method 500 may conclude at a block 508. The method 500 may be established by conveying information to an audience (e.g., giving a presentation). The manner of conveyance may be in an audible, pictorial, or textual format. For example, this may include a teacher giving a presentation to a group of students. In embodiments, the presentation may be given in a physical setting, such as a classroom or town hall. In certain embodiments, the presentation may be given in a virtual setting, such as an online forum or through a telecommunications application software.

At block 502, presentation data may be monitored and collected from the presentation in order to extract context information from the presentation data. Based upon the context information, a subject matter topic for the presentation and a presentation technique for the presentation may be determined. In this disclosure, context information may be a combination of data collected. Context information can include audio data (e.g., audible content, intonation, pitch), video data (e.g., recorded camera footage), image data (e.g., captured images, photographs) or textual data (e.g., handwritten notes, message board posts). In embodiments, collecting the presentation data may include analyzing the audio, video, image, or textual data collected to extract context information. Analyzing the data may include classifying the amount and respective proportions of the data collected. For example, in a presentation where a teacher verbally lectures, writes on the blackboard, and includes a short video, the amount and relative proportions of the audio data (spoken words), textual data (words on the blackboard), and video/image data (captured from short video) may be analyzed to determine the circumstances that form the setting of the presentation.

A subject matter topic for the presentation can be a category of the content of the information conveyed (e.g., presentation data) to an audience (e.g., biology). The subject matter topic may include one or more concepts (e.g., prokaryotic cells/eukaryotic cells). In addition, a presentation technique for the presentation can be the manner by which context information is conveyed to an audience (e.g., slideshow presentation, video lecture, interactive class exercises, Socratic Method). The context information may be collected using a set of monitoring devices (e.g., microphones, cameras, and other sensors). In various embodiments, the set of monitoring devices may include a computer associated with a presentation. For example, in a physical setting such as a classroom, slideshow images used to demonstrate a particular concept or video lectures may be captured through a camera. In another physical setting, such as a town hall discussion forum, the words spoken as well as the tone and pitch of the statements may be collected. In a virtual setting, such as an educational portal, message board posts as well as written text associated with a presentation may be collected.

At block 504, presentation information may be determined. In embodiments, a subject matter topic for the presentation or a presentation technique for the presentation may be determined using natural language processing. For example, in the physical setting classroom example, images of a cell cycle shown in succession (e.g., image data) or a video of cell division (e.g., video data/audio data) may be collected at block 502, and analyzed at block 504. Accordingly, extracted context information from the presentation data can be categorized as a subject matter topic of biology and the presentation techniques of a slideshow or video. In the other physical setting town hall discussion forum example, if a speech is given on property taxes (e.g., audio data), the spoken words, tone and pitch may be collected at block 502. The audio data may then be analyzed at block 504 such that the extracted context information from the presentation data is categorized as a subject matter topic of taxes and the presentation technique as a verbal speech or interactive discussion. In the virtual setting educational portal, if an online classroom discussion is taking place between an instructor and members of the classroom on the powers of the executive branch (e.g., textual data), the written words of the comments may be collected at block 502. The textual data may be analyzed at block 504 such that the extracted context information from the presentation data is categorized as a subject matter topic of constitutional law and the presentation technique as an online Socratic Method.

In embodiments, determining the subject matter topic for the presentation may be used to identify a concept within the subject matter topic. The context information for the presentation may be analyzed to identify the concept. In further embodiments, each subject matter topic may include a set of related concepts. A set of related concepts may be identified using a QA system, such as the one described in FIGS. 1-3. Once the concept and the set of related concepts are identified, a correlation may found between the concept and the set of related concepts. The correlation may be used to select or eliminate concepts from the set of related concepts depending upon the context information. For instance, in the physical classroom setting described above, if a subject matter topic of biology is determined and the concepts of “mitosis”, “meiosis”, and “prison” are suggested, the “prison” concept may be eliminated because although the audio data included the word “cell”, within the context of the biology, the term “prison” is not related. Based upon the identified concept within the subject matter topic, a subset of presentation techniques for the concept may be retrieved from a corpus of presentation techniques for the subject matter topic.

At block 506, an evaluation may be generated. In embodiments, the evaluation may be generated by comparing the presentation technique for a subject matter topic with a corpus of presentation techniques for the same subject matter topic. The corpus of presentation techniques for the same subject matter topic can be a collection of methods of delivery for conveying information. In certain embodiments, the corpus of presentation techniques for the same subject matter topic can include a collection of previously evaluated methods of delivery for conveying information. The evaluation may be presented through a graphical user interface on a network portal, similar to the user interface module 405 in FIG. 4. In various embodiments, the evaluation may include generating a curriculum for the presentation technique on a related concept (e.g., suggested presentation techniques for concepts related to the presentation being evaluated). For example, in the physical classroom setting example, once the context information has been classified as a subject matter topic of biology and the presentation techniques of a slideshow or video, a corpus of presentation techniques for biology is retrieved and presentation techniques associated with the concepts of the cell cycle and cell division are identified within the corpus of presentation techniques. Once the presentation techniques associated with the concepts of the cell cycle and cell division have been identified, the slideshow and video presentation techniques used to demonstrate the cell cycle and cell division are compared with other presentation techniques used to demonstrate cell cycle and cell division (e.g., cell cycle interactive classroom exercises/cooperative learning or cell division biology experiments/inquiry-based learning). The results of the comparison and the evaluation may then be displayed on the graphical user interface or be made available to the instructor in a comparable manner. The results may include suggested alternative techniques for presenting on the concepts of the cell cycle and cell division.

In the other physical setting town hall discussion forum example, once the context information has been classified as a subject matter topic of topic of taxes and the presentation technique as a verbal speech or interactive discussion, a corpus of presentation techniques for taxes is retrieved and presentation techniques associated with the concept of property taxes are identified within the corpus of presentation techniques. Once the presentation techniques associated with the concept of property taxes have been identified, the verbal speech and interactive discussion techniques used to discuss property taxes are compared with other presentation techniques used to discuss property taxes. For example, techniques such as including visual displays (e.g., charts) in conjunction with a verbal speech or an informal debate between two contrasting viewpoints. The results of the comparison and the evaluation may then be displayed on the graphical user interface or be made available to the speaker in a comparable manner. The results may include suggested alternative techniques for presenting on the concept of property taxes.

In the virtual setting educational portal message board posting example, once the context information has been classified as a subject matter topic of constitutional law and the presentation technique as the online Socratic method, a corpus of presentation techniques for constitutional law is retrieved and presentation techniques associated with the concept of the powers of the executive branch are identified within the corpus of presentation techniques. Once the presentation techniques associated with the concept of the powers of the executive branch have been identified, the online Socratic method technique used to discuss the powers of the executive branch are compared with other presentation techniques used to discuss the powers of the executive branch (e.g., independent student research or implementing a telecommunications application software to have one on one discussions between an instructor and a student). The results of the comparison and the evaluation may then be displayed on the graphical user interface or be made available to the instructor in a comparable manner. The results may include suggested alternative techniques for presenting on the concept of the powers of the executive branch.

The method 500 may conclude at block 508. Aspects of the method 500 may provide benefits associated with increased efficiency when teaching or demonstrating a concept. Altogether, an individual utilizing a suggested presentation technique for a concept may become more effective in conveying the information for the concept.

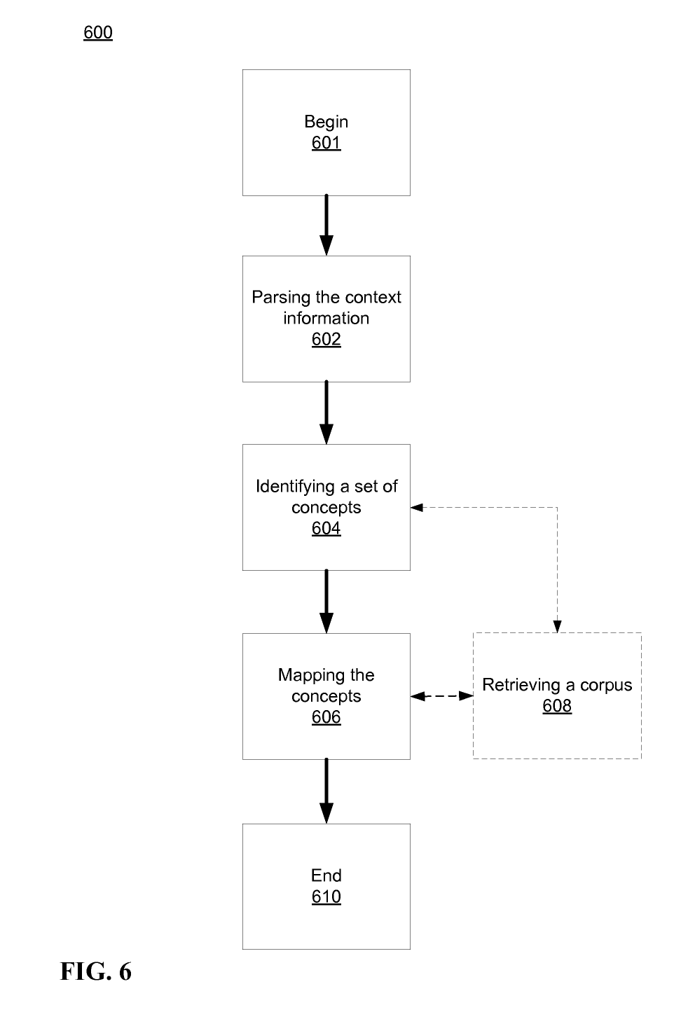

FIG. 6 is a flowchart illustrating a method 600 for determining a subject matter topic for a presentation and a presentation technique for the presentation according to embodiments. The method 600 may begin at block 601. The method 600 may include parsing the context information at block 602, identifying a set of concepts at block 604, mapping the concepts at block 606, and retrieving a corpus at block 608. The method 600 may conclude at a block 610. The method 600 may begin by collecting context information associated with a presentation. Aspects of method 600 may be similar or the same as aspects described in FIG. 4 with respect to the context information module 408.

At block 602, extracted context information from presentation data is analyzed to classify a concept. In embodiments, parsing/classifying may include utilizing a natural language processing technique configured to analyze syntactic and semantic content. The natural language processing technique may be configured to parse structured data (e.g., tables, graphs) and unstructured data (e.g., textual content containing words, numbers). In certain embodiments, the natural language processing technique may be a software tool or other program configured to analyze and identify the semantic and syntactic elements and relationships present in the context information collected. More particularly, the natural language processing technique can be configured to parse the grammatical constituents, parts of speech, context, and other relationships (e.g., modifiers) of the presentation data. The natural language processing technique can be configured to recognize keywords, contextual information, and metadata tags associated with words, phrases, or sentences for a subject matter topic. In certain embodiments, the natural language processing technique can analyze summary information, keywords, figure captions, or text descriptions included in the presentation data, and identify syntactic and semantic elements for a concept. The syntactic and semantic elements can include information such as word frequency, word meanings, text font, italics, hyperlinks, proper names, noun phrases, parts-of-speech, or the context of surrounding words. Other syntactic and semantic elements are also possible.

For instance, in the physical classroom setting example where images of a cell cycle were shown in succession, at block 602, the captions underneath or within the images may be identified, such as “Interphase”, “Prophase”, “Prometaphase”, and “Telophase” and analyzed to determine the subject matter topic of the presentation as biology. In addition, at block 602, based upon the subject matter topic of biology and the order by which the captions were presented (e.g., within a biology context), it may be identified that the presentation is for a concept of the cell cycle. In the other physical classroom setting example where a video lecture is presented on cell division, at block 602, an audible explanation of a comparison between Mitosis and Meiosis may be identified and analyzed to determine the subject matter topic of the presentation as biology. In addition, based upon the subject matter topic of biology and the audible words used, such as “diploid” and “haploid” (e.g., within a biology context), it may be identified that the presentation is for a concept of cell division.

In another physical setting, such as the town hall discussion forum where a speech was given on property taxes, at block 602, the audible content on “forecasted revenue for funding government expenses” may be identified and analyzed to determine the subject matter topic of the presentation as taxes. Moreover, based upon the subject matter topic of taxes and the audible words used, such as “real estate” or “personal property” (e.g., within a tax context), it may be identified that the presentation is for a concept of property taxes. In the virtual setting educational portal example where an online classroom discussion took place on the powers of the executive branch, at block 602, the words written within the discussion forum, such as “executive”, “legislature”, “judiciary” and “legal relationship” may be identified and analyzed to determine the subject matter topic of constitutional law. Based upon the subject matter topic of constitutional law and the written statements by the group, such as “veto” and “commander-in-chief” (e.g., within a constitutional law context), it may be identified that the presentation is for a concept of powers of the executive branch.

At block 604, a set of related concepts may be identified by comparing the concept with an ontology framework. In embodiments, an ontology framework may be a framework of structured relationships that may be organized such that related concepts are linked together and stored in a corpus of presentation techniques for a concept at block 608. In certain embodiments, the ontology framework may provide suggestions which include concepts that are selected from a corpus of concepts. For instance, in the physical classroom setting where presentations occurred on the concepts of cell cycle and cell division, at block 604, related concepts such as DNA replication or mitochondria may be grouped with the concepts cell cycle and cell division. In the town hall discussion forum where a speech was given on property taxes, block 604, related concepts such as the Internal Revenue Service or the Department of the Treasury may be grouped with the concept of property taxes. In the virtual setting educational portal where a discussion took place on the powers of the executive branch, at block 604, related concepts such as state sovereignty or democracy may be grouped with the concept of the powers of the executive branch.

At block 606, the concept classified at block 602 may be mapped with the set of related concepts identified at block 604 under a general subject matter topic (e.g., biology, taxes, constitutional law). In embodiments, the mapping may occur within a corpus of presentation techniques at block 608 (e.g., a collection of methods of delivery for conveying information). The method may conclude at block 610. Aspects of the method 600 may provide a corpus of categorically sorted presentation techniques for a variety of concepts to be used in evaluating the presentation techniques originally used by the presenter.

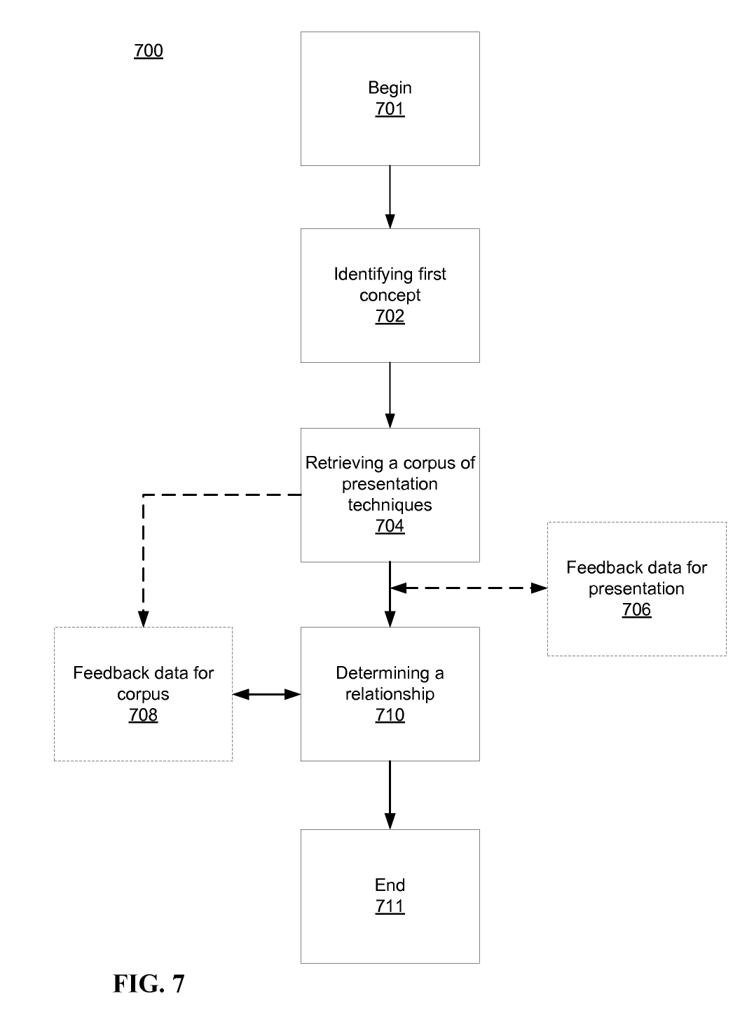

FIG. 7. is a flowchart illustrating a method 700 for comparing a presentation technique for a subject matter topic with a corpus of presentation techniques for the same subject matter topic. The method 700 may begin at block 701. The method 700 may begin after presentation data for a subject matter topic is conveyed from an entity and collected using a set of monitoring devices. The method may include identifying a concept for a presentation technique using natural language processing at block 702 and retrieving a corpus of presentation techniques for a concept from a corpus of techniques for a subject matter topic at block 704. Feedback data for the presentation may be collected at block 706 and feedback data for a corpus of presentation techniques for the concept may be collected at block 708. At block 710, based upon feedback data for the presentation technique at block 706 and feedback data for the corpus of presentation techniques for a concept at block 708, a relationship between the presentation technique for the concept and the corpus of presentation techniques for the concept may be determined. The method 700 may conclude at block 711.

At block 702, a concept for a presentation technique may be identified using natural language processing. Aspects of the method 700 may be similar or the same as aspects described in FIG. 6 with respect to block 602 (e.g., a concept being identified by parsing the context information). At block 704, a corpus of presentation techniques for the concept may be retrieved from a corpus of presentation techniques for the subject matter topic. Aspects of the method 700 may be similar or the same as aspects described in FIG. 4 with respect to the corpus of concepts module 420.

At block 706, feedback data for a presentation may be collected. In embodiments, the feedback for the presentation technique may include data collected from user communications through a set of monitoring devices. In various embodiments, feedback data may be provided through a graphical user interface (e.g., FIG. 4 user interface module 405) by users (e.g., instructors, presenters) who convey information using a particular presentation technique. In an educational embodiment, feedback data may be inferred by test scores of students who received a given presentation or by survey results collected at the end of a given presentation through a graphical user interface. The feedback data collected at block 706 may be stored in block 708 for future retrieval. Aspects of the method 700 may be similar or the same as aspects described in FIG. 5 with respect to block 502 (e.g., context information being collected through a set of monitoring devices).

For example, in a physical classroom setting where images of a cell cycle were shown and a video lecture was presented, audible comments made by students regarding the cell cycle or the results of an examination on cell division may be collected and mapped to the identified presentation techniques of a slideshow and video within a corpus of presentation techniques, respectively. The feedback data collected (e.g., audible comments, results of an examination) may be stored and mapped with the presentation techniques of slideshow and video lecture the corpus. In the other physical setting town hall discussion forum example where a speech was given on property taxes, audible comments or questions made by members of the audience, including the tone and pitch of the comments, may be collected and mapped to the identified presentation techniques of a verbal speech or interactive discussion within a corpus of presentation techniques. The feedback data collected (e.g., comments made in opposition to a raise in property taxes) may be stored and mapped with the presentation techniques of a verbal speech or interactive discussion in the corpus. In the virtual setting educational portal example where an online classroom discussion took place on the powers of the executive branch, message board comments or answers from homework questions may be collected and mapped to the identified presentation technique online Socratic Method within a corpus of presentation techniques. The feedback data collected (e.g., message board posts, homework answers) may be stored and mapped with the presentation techniques of an online Socratic Method in the corpus.

At block 708, feedback data can be collected from a corpus of presentation techniques for the concept. In embodiments, feedback data may include descriptive remarks from users. In certain embodiments, the feedback data may include a rating indicating the perceived value for a particular presentation technique for a concept (e.g., a score value assigned by the user). In various embodiments, the type of feedback data collected (e.g., from monitoring devices, from graphical user interface) may be aggregated and combined based on the type of presentation technique implemented. The corpus of presentation techniques for the concept may include a corpora of previously collected presentation techniques mapped with respective feedback data for a concept. For instance, in the physical classroom setting where audible comments were made by students regarding a slideshow presentation or the results of an examination on the video lecture were provided, student answers from an interactive classroom exercise or the lab reports from an experiment from the corpus of presentation techniques for the concept (e.g., cell cycle, cell division) may be collected. In the other physical setting town hall discussion forum example where audible comments or questions were made by members of the audience regarding a verbal speech, audience questions or responses from an informal debate between two contrasting viewpoints from the corpus of presentation techniques for the concept (e.g., property taxes) may be collected. Finally, in the virtual setting educational portal example where message board comments were made or answers from homework questions were analyzed, the text of an independent student research paper from the corpus of presentation techniques for the concept (e.g., powers of the executive branch) may be collected.

At block 710, both the feedback data collected from the corpus of presentation techniques for the concept and the feedback data collected from the presentation technique can be analyzed to determine a relationship. In embodiments, the relationship may indicate an efficacy of a presentation technique as it relates to a concept (e.g., retention of information from the presentation), the relationship may indicate the credibility of a presentation technique as it relates to a concept (e.g., reliability of presentation techniques to demonstrate the context information), or the relationship may indicate the progress of a presentation technique as it relates to a concept (e.g., the development of the instructor as compared with other instructors).

For example, in the physical classroom setting example where feedback data for the presentation technique was collected (e.g., audible comments, results of an examination) and feedback data from the corpus of presentation techniques for the concept was collected (e.g., student answers from an interactive classroom exercise or the lab reports from an experiment), it may be determined that the interactive classroom exercise is a more efficient presentation technique to demonstrate the concept of the cell cycle or that an experiment is a more efficient presentation technique to demonstrate the concept of cell division. In the other physical setting town hall discussion forum example where feedback data for the presentation technique was collected (e.g., audible comments by members of the audience) and feedback data from the corpus of presentation techniques for the concept was collected (e.g., audible questions by members of the audience), it may be determined that the informal debate between two contrasting viewpoints is a more efficient presentation technique to demonstrate the concept of property taxes. In the virtual setting educational portal example where feedback data for the presentation technique was collected (e.g., message board posts, homework answers) and feedback data from the corpus of presentation techniques for the concept was collected (e.g., text of an independent student research paper), it may be determined that an online Socratic method is a more efficient presentation technique to demonstrate the concept of the powers of the executive branch.

The method 700 may conclude at block 711. Aspects of the method 700 may provide benefits associated with evaluating manners of conveying information for a concept. Altogether, an instructor or speaker may become more effective in demonstrating the concept. Finally, by identifying topics in a lecture and correlating the topics to an evaluation of an audience of a presentation, the method 700 may allow a more granular evaluation of the implementation of a presentation technique as it relates to a concept.

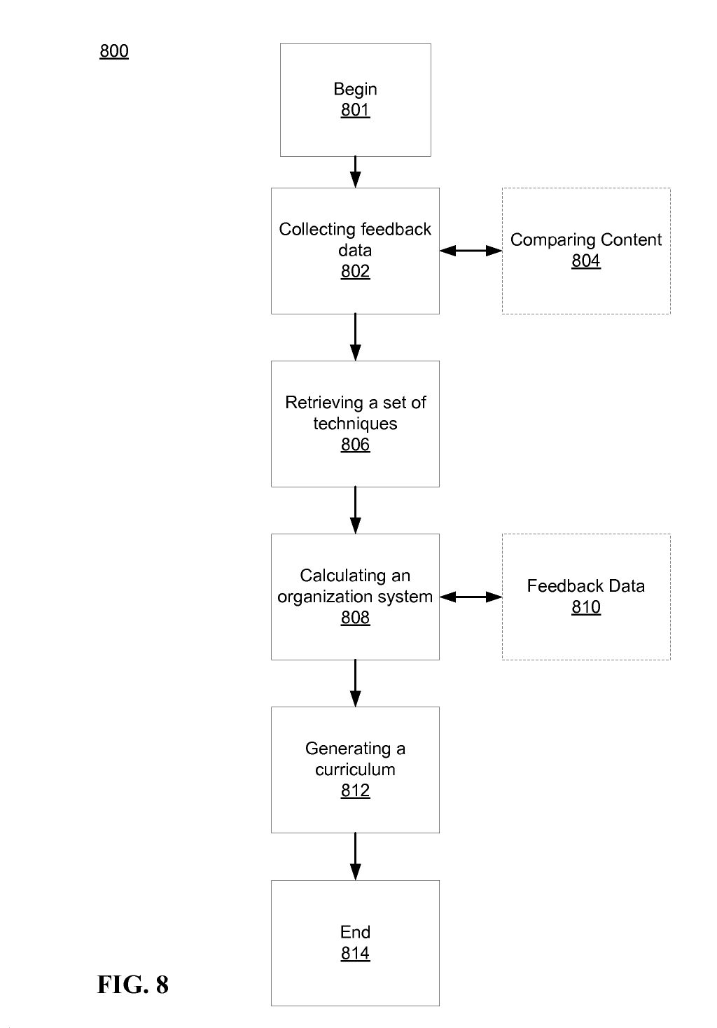

FIG. 8 is a flowchart illustrating a method 800 for generating an evaluation of a presentation technique for a subject matter topic according to embodiments. In various embodiments, the method 800 may include evaluating an educational presentation, the educational presentation including one or more concepts. The method 800 may begin at block 801. The method 800 may begin after a subject matter topic for a presentation and a presentation technique for a presentation has been determined. Aspects of method 800 may be similar or the same as aspects described in FIG. 6 with respect to the method 600 for determining a subject matter topic for a presentation and a presentation technique for the presentation. In certain embodiments, the method 800 may include collecting feedback data associated with a communication made by a user on a presentation technique for a concept at block 802, comparing the content of a communication made by a user with the content of a presentation technique on a concept at block 804, retrieving a set of previously evaluated presentation techniques related to the concept at block 806, and calculating an organization system of the set of previously evaluated presentation techniques corresponding to the presentation technique on the concept at block 808. The method 800 may include generating a curriculum for the presentation technique on the concept at block 812. The method 800 may conclude at block 814.

At block 802, feedback data associated with a communication made by a user on a presentation technique for a concept may be collected. Aspects of method 800 may be similar or the same as aspects described in FIG. 7 with respect to collecting feedback data for a presentation at block 706. At block 804, using natural language processing, the content of a communication made by a user (e.g., feedback data) may be compared with the content of the presentation of the presentation technique on the concept (e.g., substance of the information conveyed). Aspects of method 800 may be similar or the same as aspects described in FIG. 6 with respect to utilizing a natural language processing technique configured to analyze syntactic and semantic content at block 602. For example, in the physical classroom setting where a video lecture was presented on cell division, if an examination was given on cell division, the written student answers (e.g., textual data) would be compared with the audible narration and visual content displayed during the video lecture (e.g., audio data, video data) such that the written student answers may be analyzed according to accuracy (e.g., retention of information). Specifically, if the video lecture stated “Cell division is the process by which a parent cell divides into two or more daughter cells” and a student answer for an examination question asking for the definition of cell division contained the following text “Cell division is a replication process with the purpose of passing on hereditary genetic material”, the audio, video, and textual data may be compared simultaneously. It may be determined that because both the student answer and the video lecture called cell division a “process”, the student answer used the words “passing” referring to “hereditary” and the video lecture used the words “divides” referring to “parent/daughter”, the student answer is accurate and therefore an indication that the video lecture for cell division (e.g., a concept) is an effective presentation technique within a subject matter topic (e.g., biology).

At block 806, a set of presentation techniques related to the concept may be retrieved. In embodiments, the set of presentation techniques related to the concept may have been previously evaluated using the method 800 and stored in a corpus for future retrieval. Aspects of method 800 may be similar or the same as aspects described in FIG. 4 with respect to the corpus of evaluations module 422. For example, in the physical classroom setting, after the subject matter topic of biology, concept of cell division, and presentation technique of video lecture have been identified, presentation techniques previously used and evaluated for cell division (e.g., classroom experiments, interactive discussions) may be retrieved.

At block 808, an organization system may be calculated. In embodiments, the organization system may include a set of previously evaluated presentation techniques corresponding to a presentation technique on a concept. The organization system may be based upon feedback data from block 810. The feedback data may be collected from multiple entities. In certain embodiments, cognitive style computing and machine learning techniques may be employed to analyze and evaluate presentation techniques which have historically been effective relative to the needs of the user conveying information. In certain embodiments, the cognitive style computing and the machine learning techniques may be used to determine which presentation techniques may be recommended for use over time (e.g., in what specific contexts or delivery manners) once a set of presentation techniques related to the concept are retrieved. In additional embodiments, the feedback data may indicate the accuracy of context information retained by audience members as it relates to different presentation techniques on the same concept. The feedback data may indicate the efficacy of a presentation technique as it relates to other presentation techniques on the same concept.

For example, in the physical classroom setting, the feedback data related to the classroom experiments for cell division would be compared with the feedback data related to the interactive discussions for cell division and the feedback data related to the video lecture for cell division. Based upon the comparison, the organization system may rank the presentation techniques for cell division from most effective to least effective. Therefore, the organization system may calculate that previous presentation techniques utilizing classroom experiments are more effective for understanding the concept of cell division than interactive discussions for cell division which are more effective than a video lecture for cell division.

At block 812, in response to calculating an organization system, a curriculum for the presentation technique on the concept may be generated. In embodiments, the curriculum for the presentation technique on the concept may include related concepts within a subject matter topic. For example, if the organization system for the physical classroom setting calculated that a classroom experiment was the most effective presentation technique for understanding cell division, the calibrated curriculum may then determine additional presentation techniques for related concepts to supplement demonstrating the concept of cell division. For instance, in addition to calculating that the most effective presentation technique for understanding cell division is a classroom experiment, the curriculum may determine that an interactive discussion on chromosomes followed by a video lecture on mitochondria is an effective curriculum for these concepts within the subject matter topic of biology.

The method may conclude at block 814. Aspects of method 800 may provide individuals/entities (e.g., educational institutions) with an indication as to how effective or ineffective a presentation technique is for a concept. In evaluating presentation techniques, individuals/entities (e.g., government institutions) may be able to engage their audiences and convey information in a more efficient manner.

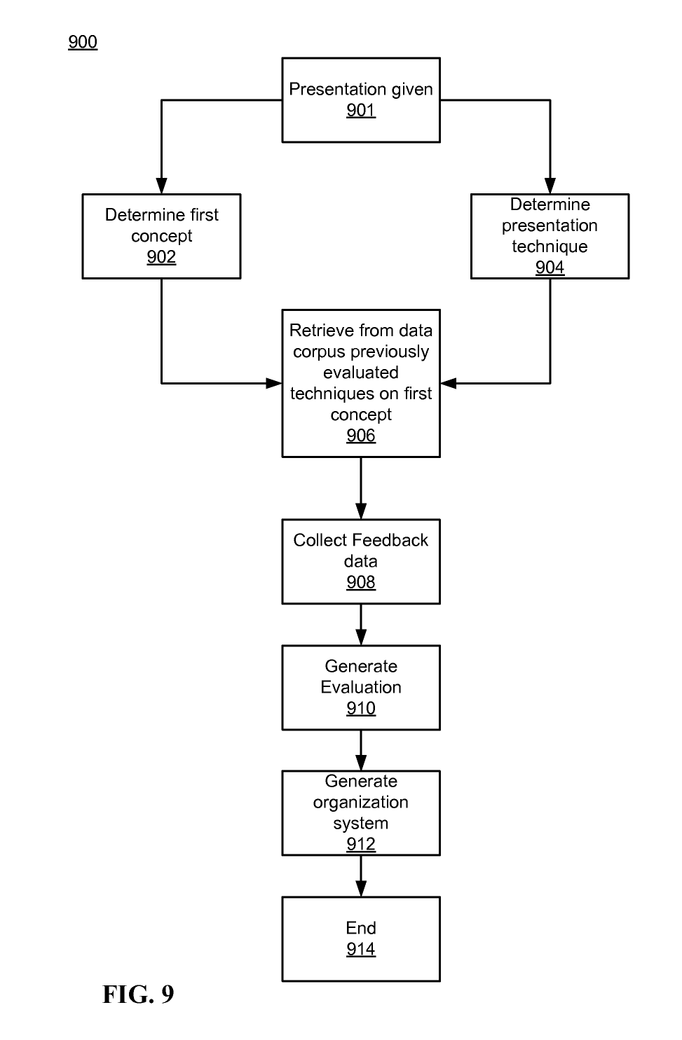

FIG. 9 is a flowchart illustrating a method 900 for evaluating presentation data according to embodiments. At block 901, the method may begin by a presentation being performed. In embodiments, a presentation may include a manner of delivery for conveying information. For example, in a virtual setting educational portal, an instructor may hold a real time group discussion through a telecommunications application software.

At block 902, a concept may be determined from context information extracted from collected presentation data. Aspects of method 900 may be similar or the same as aspects described in FIG. 5 with respect to block 502 (e.g., presentation data collected). Aspects of method 900 may be similar or the same as aspects described in FIG. 6 with respect to block 602 (e.g., parsing collected context information to classify a concept). For instance, in the virtual educational portal where an instructor is holding a real time group discussion through a telecommunications application software, the audible content from the discussion (e.g., audio data) and typed student communications (e.g., textual data) may be collected. The block 902 may identify and analyze the spoken and written words within the discussion, such as “particles”, “electric fields”, and “interactions”, and determine a subject matter topic of fundamental forces and a concept of electromagnetism.

At block 904, a presentation technique for the presentation may be determined. Aspects of method 900 may be similar or the same as aspects described in FIG. 5 with respect to block 504 (e.g., determining a presentation technique using natural language processing). For instance, in a virtual setting educational portal where an instructor is audibly communicating with members of the class (e.g., audio data) or is responding to questions through message posting (e.g., textual data), the block 904 may identify and analyze the spoken and written words. It may be determined that, based upon the context information, the type of data received as well as the data received itself, a direct instruction presentation technique is being utilized.

At block 906, previously evaluated presentation techniques for the concept may be retrieved. Aspects of method 900 may be similar or the same as aspects described in FIG. 4 with respect to the corpus of concepts module 420 (e.g., a collection of presentation techniques used for a concept classified under a subject matter topic) or as aspects described in FIG. 8 at block 806. For instance, after identifying the concept (e.g., electromagnetism) and the presentation technique (e.g., direct instruction), previously evaluated presentation techniques on electromagnetism may be retrieved, such as inquiry-based learning, cooperative learning or video lectures.

At block 908, feedback data may be collected. Aspects of method 900 may be similar or the same as aspects described in FIG. 8 with respect to block 802 (e.g., feedback data associated with a communication made by a user on a presentation technique collected). In embodiments, feedback data from previously evaluated presentation techniques retrieved in block 906 may be collected at block 908. For instance, in the virtual setting educational portal example, if the teacher gave homework assignments on the concept of electromagnetism or students were given a survey to evaluate their perception of the presentation technique or the concept, the written student answers would be collected and analyzed using natural language processing. Additionally, examination answers following an inquiry based learning presentation technique on electromagnetism or student responses to a cooperative learning presentation technique on electromagnetism may be collected.

At block 910, an evaluation may be generated. Aspects of method 900 may be similar or the same as aspects described in FIG. 7 with respect to block 710 (e.g., analyzing feedback data to determine a relationship) or FIG. 8 with respect to block 804 (e.g., comparing the content of a user communication with the content of a presentation technique). For example, in the virtual setting educational portal example, the written student answers from the homework or evaluation (e.g., textual data) would be compared with the audible narration (e.g., audio data) from the direct instruction on electromagnetism such that the written student answers may be analyzed according to efficacy (e.g., amount of time spent using a presentation technique as it relates to the level of retention of presentation data conveyed in the presentation). The results of the comparison may be displayed through a graphical user interface on a network portal, similar to the user interface module 405 in FIG. 4. In embodiments, the results displayed on the user interface may include other comparisons or relationships determined (e.g., credibility, progress).

At block 912, an organization system may be generated. In embodiments, the evaluation generated at block 910 may be compared with the corpus of previously evaluated presentation techniques for the concept retrieved at block 906 to generate an organization system. Aspects of method 900 may be similar or the same as aspects described in FIG. 8 with respect to block 808 (e.g., calculating an organization system). For instance, in the virtual setting educational portal example, the feedback data related to direct instruction for electromagnetism would be compared with the feedback data related to an inquiry based presentation technique on electromagnetism and the feedback data related to a cooperative learning presentation technique on electromagnetism. Based upon the comparison, the organization system may rank the presentation techniques for the concept (e.g., electromagnetism) from most efficient to least efficient with respect to time spent demonstrating a concept as it relates to retention of presentation data from a presentation. Therefore, the organization system may calculate that the previous presentation techniques utilizing inquiry based techniques are more time efficient for demonstrating the concept of electromagnetism than cooperative presentation techniques for electromagnetism which are more efficient than direct instruction techniques for electromagnetism.

The method may conclude at block 914. Aspects of method 900 may provide individuals/entities with alternative presentation techniques to be able to improve demonstrating concepts. In improving an ability to demonstrate a concept, individuals/entities may have an objective understanding as to how their presentation techniques compare to other individual's/entities' presentation techniques.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present disclosure is not necessarily limited to such applications, various aspects of the disclosure may be appreciated through a discussion of various examples using this context.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1-18. (canceled)

19. A computer program product for evaluating presentation data, the computer program product comprising a computer readable storage medium having program instructions embodied therewith, wherein the computer readable storage medium is not a transitory signal per se, the program instructions executable by a processor to cause the processor to perform a method comprising:
monitoring a presentation, using a set of monitoring devices, to collect presentation data from a presentation;
analyzing the presentation data to extract context information from the presentation data;
determining, based on the context information for the presentation, a subject matter topic for the presentation and a presentation technique for the presentation;
analyzing, based on the subject matter topic, the context information for the presentation to identify a concept within the subject matter topic;
retrieving, from a corpus of presentation techniques for the subject matter topic, a subset of presentation techniques for the concept; and
generating, by comparing feedback data for a determined presentation technique and feedback data from a corpus of presentation techniques for the concept, an evaluation of the presentation technique pertaining to the concept.

20. A computer system for managing a set of data associated with a corpus, the computer system comprising:
a memory; and
a processor in communication with the memory, wherein the computer system is configured to perform a method, the method comprising:
monitoring a presentation, using a set of monitoring devices, to collect presentation data from a presentation;
analyzing the presentation data to extract context information from the presentation data;
determining, based on the context information for the presentation, a subject matter topic for the presentation and a presentation technique for the presentation;
analyzing, based on the subject matter topic, the context information for the presentation to identify a concept within the subject matter topic;
retrieving, from a corpus of presentation techniques for the subject matter topic, a subset of presentation techniques for the concept; and
generating, by comparing feedback data for a determined presentation technique and feedback data from a corpus of presentation techniques for the concept, an evaluation of the presentation technique pertaining to the concept.
